(19) United States
(12) Patent Application Publication
(10) Pub. No.: US 2026/0045681 A1
(43) Pub. Date: Feb. 12, 2026

(54) Nonlinear Antenna

(71) Applicant: Central Intelligence Agency, Washington, DC (US)

(72) Inventors: Carey G. Buxton, Spotsylvania, VA (US); Timothy M. Larsen, Fairfax, VA (US)

(73) Assignee: Central Intelligence Agency, Washington, DC (US)

(21) Appl. No.: 19/289,362

(22) Filed: Aug. 4, 2025

Related U.S. Application Data
(60) Provisional application No. 63/679,710, filed on Aug. 6, 2024.

(51) Int. Cl. H01Q 1/24; H01Q 3/36; H01Q 9/06

(52) U.S. Cl. CPC H01Q 1/247; H01Q 3/36; H01Q 9/065

(57) ABSTRACT

A nonlinear antenna is disclosed which includes a driven element configured to receive a signal of frequency fi incident to the driven element, and a switch electrically connected to the driven element and configured to increase an electrical size of the driven element by interrupting a current flow in the driven element by switching on and off at a switching frequency fsw that is higher than the incident frequency fi.

### CROSS REFERENCE TO RELATED APPLICATIONS

This application claims the benefit of and priority to U.S. Patent Application Ser. No. 63/679,710 filed Aug. 6, 2024, the entire contents of which are herein incorporated by reference.

### NOTICE OF GOVERNMENT RIGHTS

The United States Government has rights in this invention pursuant to the employer-employee relationship of the Government to at least one inventor.

### FIELD

The present subject matter relates to non-LTI (Linear Time-Invariant) antennas (nonlinear antennas).

### BACKGROUND

Smart phones, smart watches, radio controlled clocks, Wi-Fi devices, and Internet of Things (IoT) devices use antennas to transmit and/or receive signals. While the electronics in these devices and batteries continue to get smaller, size reductions are limited by their antennas, as it is difficult to reduce antenna size without sacrificing performance. If an antenna is physically much smaller than the wavelength of the signal it is meant to send or receive it can still be tuned to the right frequency using tuning circuits. Tuning circuits, however, narrow the usable antenna signal bandwidth, often to the point that the bandwidth becomes too small for practical communication. A need therefore exists for an electrically small antenna that does not sacrifice performance for a reduction in antenna size.

### SUMMARY

Disclosed is a nonlinear antenna which includes a driven element configured to receive a signal of frequency fi incident to the driven element, and a switch electrically connected to the driven element and configured to increase an electrical size of the driven element by interrupting a current flow in the driven element by switching on and off at a switching frequency fsw that is higher than the incident frequency fi. In certain exemplary embodiments, the switch switching frequency fsw is adjustable.

Certain exemplary embodiments include a wireless device which has a communication element configured to receive an electromagnetic signal, an antenna connected to the communication element having a driven element configured to receive a signal of frequency fi incident to the driven element, and a switch electrically connected to the driven element and configured to increase an electrical size of the driven element by interrupting a current flow in the driven element by switching on and off at a switching frequency fsw that is higher than the incident frequency fi. Certain exemplary embodiments include any nonlinear antenna configured to receive an incident signal waveform selected from the group consisting of an AM signal, an FM signal, a PSK signal, an FDMA signal, a TDMA signal, a CDMA signal, and an OFDM signal.

Another embodiment includes a method of inducing a nonlinear effect on an antenna boundary which includes receiving an electromagnetic signal of a first frequency incident to an antenna boundary, and increasing an electrical size of the antenna by opening and closing an antenna conducting path at a second frequency that is higher than the first frequency. Another exemplary embodiment includes a method of inducing a nonlinear effect on an antenna by receiving an electromagnetic signal of a frequency fi incident to an antenna boundary, switching a switch on and off at a switching frequency fsw, and interrupting a current flow in the driven element, causing the current flow to change direction. In certain exemplary embodiments the switch switching frequency fsw is adjustable.

### BRIEF DESCRIPTION OF THE FIGURES

A description of the present subject matter including various embodiments thereof is presented with reference to the accompanying drawings, the description not meaning to be considered limiting in any matter, wherein:

FIG. 1 illustrates an electrically small linear antenna;

FIG. 2 illustrates an exemplary embodiment of an electrically small nonlinear antenna;

FIG. 3 illustrates test results comparing a linear electrically small antenna with a nonlinear electrically small antenna switched at 40 MHz;

FIG. 4 illustrates test results comparing a linear electrically small antenna with a nonlinear electrically small antenna switched at 80 MHz;

FIG. 5 illustrates nonlinear electrically small antenna test results performed on a software defined radio;

FIGS. 6-8 illustrate software modeling results for an electrically small nonlinear T-matched dipole antenna;

FIGS. 9-11 illustrate software modeling results for an electrically small nonlinear inverted F antenna;

FIGS. 12-14 illustrate software modeling results for an electrically small nonlinear loop antenna; and

FIG. 15 illustrates an exemplary embodiment of a wireless device incorporating a nonlinear electrically small antenna.

Similar reference numerals and designators in the various figures refer to like elements.

### DETAILED DESCRIPTION

An electrically small antenna is an antenna whose largest dimension is significantly smaller than the wavelength of the signal it transmits or receives. This usually means the antenna's largest dimension is less than one-tenth of a wavelength. While electrically small antennas offer size advantages, they typically have limitations in bandwidth and efficiency compared to larger antennas. This is because electrically small antennas tend to have lower radiation efficiency compared to larger antennas, meaning they don't radiate or receive energy as effectively. Designing electrically small antennas that achieve acceptable performance levels can therefore be challenging due to the trade-offs between size, bandwidth, and efficiency.

A nonlinear antenna is an antenna having an output signal characteristic that is not directly proportional to an antenna incident signal. While it was widely believed by those of skill in the art that you could not create a nonlinear effect on the boundary where an electromagnetic field transitions to current on an antenna, we discovered that you create a nonlinear effect by changing the boundary condition of the antenna by disrupting the current induced in an antenna by an incident signal by cycling a switch connected to the antenna on and off faster than the frequency of the signal incident to the antenna boundary. By inducing a nonlinear effect on the boundary where an electromagnetic field of a signal incident to an antenna transitions to current on the antenna, performance in an electrically small antenna significantly improves and overcomes the deficiencies above.

This disruption in the current path induces a nonlinear time varying boundary condition on the antenna, causing a reversal in the direction of the current on the antenna while the incident signal field polarization remains constant. This reversal in the direction of the induced current on the antenna relative to the incident signal wave mimics the effects of discharging a capacitor in a circuit. Normally, a series capacitor and load resistor in parallel with a low frequencies source block the flow of current at this low frequency. For the relatively long half cycle of the low frequency source, the capacitor has very little capacity to store charge and therefore builds up voltage that reduces the flow of current through the capacitor and the load resistor. This reduces the amount of power delivered to the load.

By cycling a switch to change the direction of the current on the antenna, charge buildup on one side of the antenna more easily moves to the other side of the antenna. This change of direction of the current enables more current to flow through the load resistor of the antenna in reaction to the incident fields on the antenna, delivering more power to the load. The switching also shifts the frequency induced on the antenna by the incident wave to the incident signal frequency plus the switching frequency. This enables the antenna to perform better at incident frequencies it is not physically sized for. This shift in frequency increases the electrical size of the antenna by making it appear to be sized (tuned) to a larger wavelength than an antenna of that size would normally be tuned to, enabling a smaller antenna to receive signal energy more efficiently as if it were a larger linear antenna sized for the incident frequency. The antenna is therefore made to appear to be sized (tuned) to a desired switching frequency by adjusting the speed of the switching frequency f_{SW} is adjustable. This nonlinear effect enables an antenna to be much smaller than resonant linear antenna, but without the limitation and performance degradations of a linear electrically small antenna.

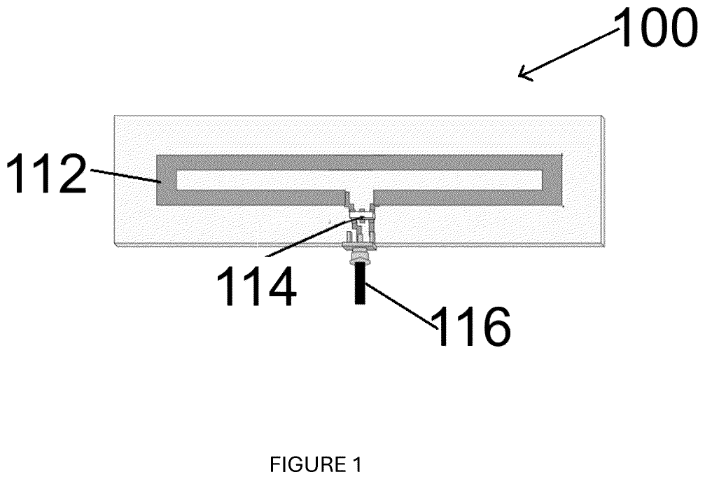

FIG. 1 illustrates an electrically small linear antenna 100. It is electrically small because it is sized for a 41 MHz incident signal but was tested using a received incident signal of approximately 1 MHz (i.e. approximately one fortieth the size of the incident wavelength). Use of a 41 MHz incident signal is exemplary only, as other signal frequencies in addition to and/or in place of the 41 MHz signal discussed below can be used without departing from the scope of the present subject matter. Antenna 100 includes a body/driven element 112 coupled to and electrically communicating with optional matching circuit 114, which is coupled to and electrically communicating with connector/cable 116 which connects with a transceiver (not shown). In the embodiment illustrated in FIG. 1, matching circuit 114 is a 4:1 impedance transformer, and connector/cable 116 is a 50 ohm coaxial cable, although other impedance matching circuits and connectors and/or cables known to those of skill in the art can be used instead of or in addition to the transformer and connector/cable of FIG. 1 without departing from the scope of the present subject matter.

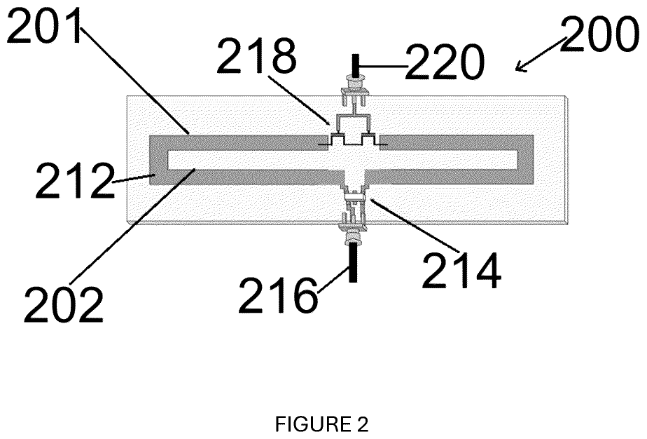

FIG. 2 illustrates an exemplary embodiment of an electrically small nonlinear antenna 200 in accordance with the present subject matter. It is electrically small because it is sized for a 41 MHz incident signal but was tested using a received incident signal of approximately 1 MHz (i.e. approximately one fortieth the size of the incident wavelength). Use of a 41 MHz incident signal is exemplary only, as other signal frequencies in addition to and/or in place of the 41 MHz signal discussed below can be used without departing from the scope of the present subject matter. Antenna 200 includes a body/driven element 212 coupled to and electrically connected with optional matching circuit 214, which is coupled to and electrically connected with connector/cable 216, which connects with a transceiver (not shown). In the exemplary embodiment of FIG. 2, matching circuit 214 is a 4:1 impedance transformer, and connector/cable 216 is a 50 ohm coaxial cable, although other impedance matching circuits and connectors and/or cables known to those of skill in the art can be used instead of or in addition to the transformer and connector/cable of FIG. 2 without departing from the scope of the present subject matter.

Antenna 200 further includes at least one switch 218 coupled to and electrically communicating with driven element 212 and connector/cable 220, where switch 218 is configured to time-vary the electrical structure of the antenna 200 faster than an incident wave frequency fi by switch 218 switching open and closed at a frequency fsw which is greater than the incident wave frequency fi. By cycling open and closed at a frequency fsw that is greater than the incident frequency fi, switch 218 disrupts the current induced in antenna driven element 212.

This disruption in the current path of driven element 212 induces a nonlinear time varying boundary condition on antenna 200, causing a reversal in the direction of the current on driven element 212 while the incident signal field polarization relative to antenna 200 remains constant. This reversal in the direction of the induced current on the antenna driven element 212 relative to the incident signal wave mimics the effects of discharging a capacitor in a circuit. Normally, a series capacitor and load resistor in parallel with a low frequency source blocks the flow of current such that it approximates an open circuit. For the relatively long half cycle of the low frequency source, the capacitor has very little capacity to store charge and therefore builds up voltage that reduces the flow of current through the capacitor and the load resistor. This reduces the amount of power delivered to a load such as a receiver, transmitter, or transceiver (not shown).

By cycling switch 218 to change the direction of the current on the antenna driven element 212, however, charge buildup on one side 201 of antenna 200 more easily moves to the other side 202 of antenna 200. This change of direction of the current on driven element 212 enables more current to flow through antenna 200 in response to the incident fields on the antenna, delivering more power to a load such as a receiver, transmitter, or transceiver (not shown). The switching also shifts the frequency induced on antenna 200 by the incident wave to the incident signal fi frequency plus the switching frequency fsw. This enables antenna 200 to perform better at frequencies it is not physically sized for. This shift in frequency makes the antenna 200 appear to be sized (tuned) to a smaller wavelength than antenna 200 is actually physically sized (tuned) for, enabling antenna 200 to transmit and/or receive signal energy more efficiently as if it were a larger linear antenna sized for the incident frequency. Antenna 200 therefore behaves as if it were sized (tuned) to switching frequency fsw (which in certain embodiments is adjustable). This nonlinear effect enables antenna 200 to function as an electrically small antenna, but without the limitations and performance degradations of linear electrically small antennas. It also introduces additional frequencies into the system, known as mixed frequencies, which are often detected on an electrically small antenna more easily than the initial incident frequency.

In the exemplary embodiment of FIG. 2, switch 218 is a MOSFET electrically connected to antenna 200. The use of a MOSFET is exemplary only, however, as other switches known to those of skill in the art can be used in place of and/or in addition to a MOSFET. Other types of field effect transistors can be used in place of and/or in addition to MOSFETs, including but not limited to a JFET, a MOSFET, a MISFET, and/or an IGFET. In still other embodiments, switch 218 can be a BJT, a Schottky diode, an optical switch, a pin diode, a Gallium Arsenide switch, and an/or IGBT. In still other embodiments switch 218 is mechanical, and in still other exemplary embodiments switch 218 is a plasma switch. The switch placement and connection configuration shown is exemplary only, as other switch locations and connections can be used with antenna 200 without departing from the scope of the present subject matter.

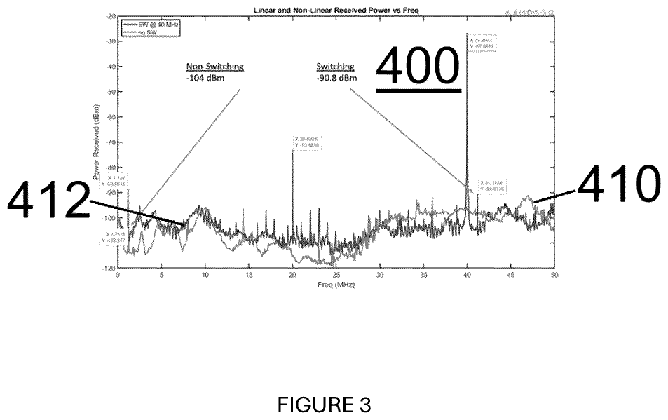

FIGS. 3-5 illustrate test results comparing a linear electrically small antenna 100 (see, e.g. FIG. 1) with a switched nonlinear electrically small antenna 200 (see, e.g., FIG. 2). The antennas were sized to be resonant at approximately 41 MHz and were tested using an incident signal from a local radio station transmitting at approximately 1 MHz. Use of a 41 MHz incident signal is exemplary only, as other signal frequencies in addition to and/or in place of the 41 MHz signal discussed below can be used without departing from the scope of the present subject matter. The received power vs frequency for both antennas was measured using a spectrum analyzer. FIG. 3 illustrates measured received power vs frequency 400 for antenna 100 and for the antenna 200 switching at 40 MHz. The linear antenna spectrum (trace 410) was measured at an incident wave frequency of 1.2176 MHz and the nonlinear antenna spectrum (trace 412) was measured at a mixed frequency of 41.2176 MHz. As shown in FIG. 3, nonlinear antenna 200 exhibited significantly better performance than linear antenna 100. The linear antenna spectrum showed received power of approximately −104 dBm, while the nonlinear antenna spectrum showed a received power of approximately −91.4 dBm. Thus, the difference in power received between the linear antenna and the nonlinear antenna (approximately 40 times smaller than a resonant antenna sized for a 1.2176 MHz signal) was approximately 12.5 dB.

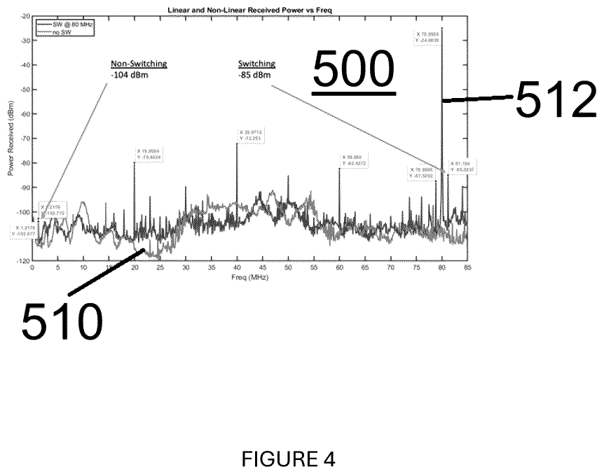

FIG. 4 illustrates measured received power vs frequency 500 of the same two antennas tested in FIG. 3, but with nonlinear antenna 200 switching at 80 MHz. The linear antenna spectrum (trace 510) was measured at an incident wave frequency of 1.2176 MHz and the non-linear antenna spectrum (trace 512) was measured at a mixed frequency of 81.2176 MHz. As shown in FIG. 4, nonlinear antenna 200 also exhibited significantly better performance than the linear antenna 100 at an 80 MHz switching rate. The linear antenna spectrum showed received power levels of approximately −104 dBm, while the nonlinear antenna spectrum showed received power levels of approximately −85 dBm. Thus, the difference in power received between linear antenna 100 and nonlinear antenna 200 (at 40 times smaller than the resonant antenna) was approximately 19 dB.

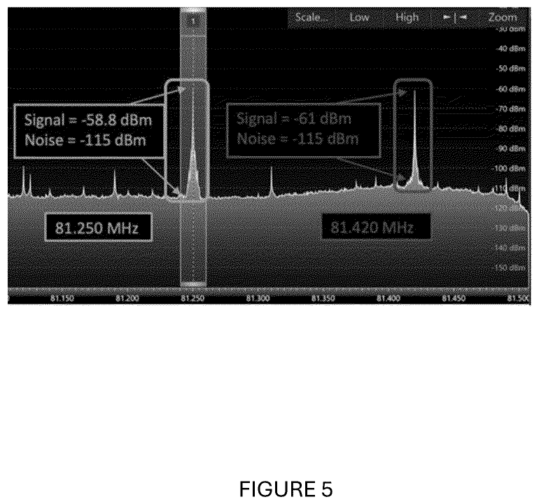

FIG. 5 illustrates test results performed on a software defined radio. In this example, a software defined radio was used to receive and demodulate mixed AM signals at 81.250 MHz and 81.420 MHz. Both signals are visible in the power spectrum shown in FIG. 5. The noise floor was approximately −115 dBm, with other signals in the area including the two AM radio signals also visible in the spectrum. The first signal at 81.250 MHz had a signal power of −58.9 dBm and has a signal to noise ratio (SNR) of 51.1 dB. The second signal at 81.420 MHz had a signal power of −61 dBm, and a SNR of 54 dB.

These frequencies are exemplary only, as other frequencies and other signal modulations can be used without departing from the scope of the present subject matter. Although not shown, testing was also conducted on linear and nonlinear antennas sized for a 360 MHz signal using a received incident signal of approximately 1 MHz. A nonlinear effect was observed beginning at a switching frequency fsw of approximately twice the incident frequency fi. Antenna performance continued to improve as the switching frequency approached the resonant frequency of the wavelength the electrically small antenna was sized/tuned for. Other signal frequency bands and/or types can also be received including, but limited to FM, FDMA, TDMA, PSK, OFDM, and/or CDMA signals without departing from the scope of the present subject matter.

The nonlinear effect discussed above can also be induced in other antenna structures can be used to create the change in current direction by applying a switch, including but not limited to a dipole antenna, a half dipole antenna, a loop antenna, an inverted-F antenna, and a T-match dipole antenna. Furthermore, although discussion focused on AM signals, the present subject matter works with other incident signal waveforms including but not limited to FM signals, PSK signals, FDMA signals, TDMA signals, CDMA signals, and OFDM signals.

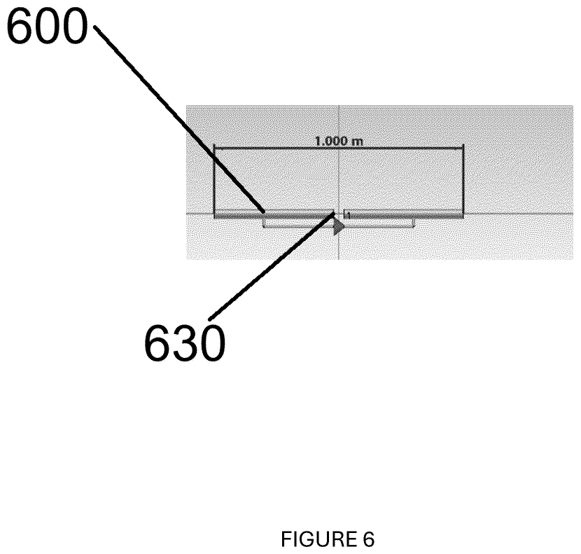

FIGS. 6-14 illustrate the results of software antenna modeling showing that nonlinear effects are also achievable on other antenna types. Modeling was performed using T-matched dipoles, inverted F antennas, and loop antennas. To demonstrate the nonlinear switching effect, antennas were modeled at the same distance from an incident plane wave. One antenna had an open circuit at the position of the switch, representing the open switch. The other antenna had a short circuit at the position of the switch, representing the closed switch. A simulated plane wave hit the antennas at the same time.

As shown in FIGS. 6-14, other antenna configurations exhibited the nonlinear behavior of the folded dipole antennas discussed above when current changed direction when the switch went from an open to a short circuit, with configurations in the T-matched dipole, the inverted F antenna, and the loop antenna showing approximately a 180° phase shift in the current at the feed point of the antenna upon switching. Modeling also showed that the amplitude of each phase can be adjusted up or down by changing a switching duty cycle by, for example, leaving a switch in the state having a lower current for a longer time to period to increase signal amplitude, or leaving the switch in the state having a higher current amplitude for a shorter time period to decrease the signal amplitude of the higher amplitude phase.

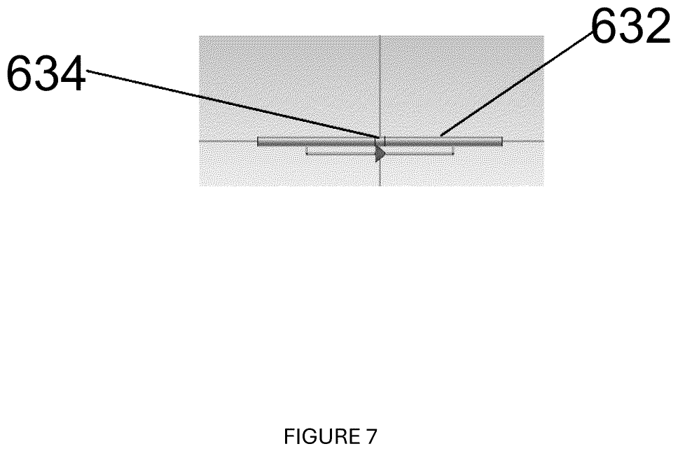

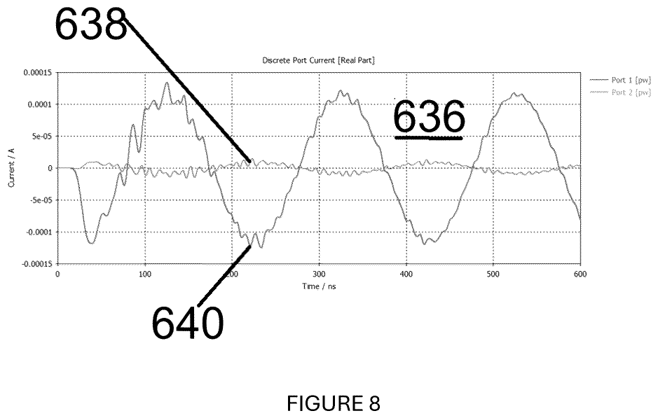

FIGS. 6-8 illustrate software modeling results for an electrically small nonlinear T-matched dipole antenna 600. FIG. 6 illustrates an electrically small nonlinear T-matched dipole antenna 600 in an open switch 630 configuration, while FIG. 7 illustrates an electrically small nonlinear T-match dipole antenna 632 in a closed switch 634 configuration. The models used a 10 MHz plane wave incident to antennas physically sized to have a resonant frequency of about 300 MHz. FIG. 8 illustrates a graph of modeled current vs time 636 for the antennas of FIGS. 6 and 7. As shown in FIG. 8, antenna current changes direction when the switch transitions from open to closed. In the model results shown, the closed short-circuit antenna has a current 638 at the feed point approximately 180 degrees out of phase from the open-circuit antenna current 640. Thus, the T-matched dipole antenna shows a 180 degree phase shift in the current at the antenna feed point upon switching from an open circuit configuration to a closed circuit configuration.

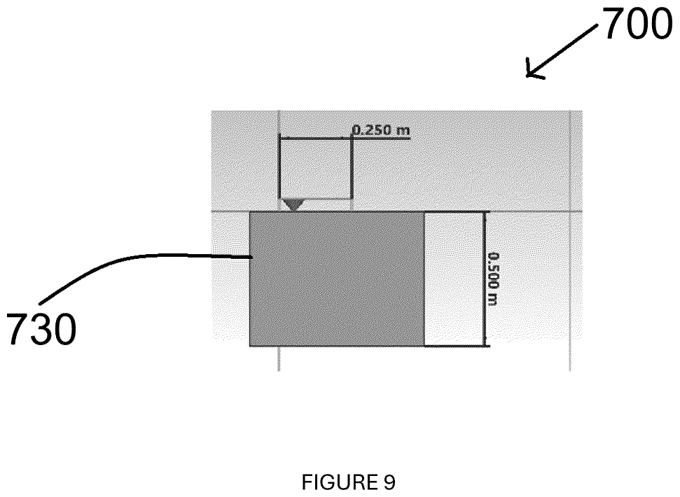

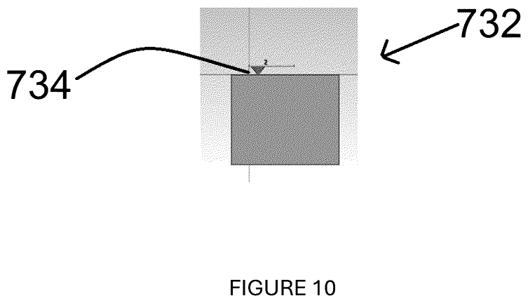

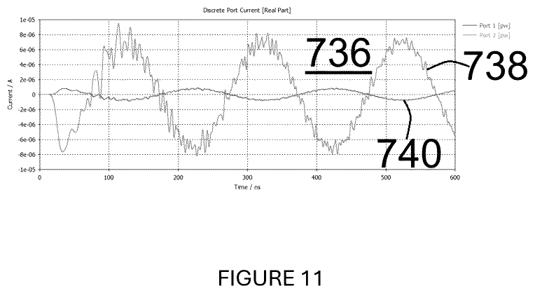

FIGS. 9-11 illustrate software modeling results for an electrically small nonlinear inverted F antenna 700. FIG. 9 illustrates results of an inverted F antenna 700 in a closed switch 730 configuration, while FIG. 10 illustrates an inverted F antenna 732 in an open switch 734 configuration. The models used a 10 MHz plane wave incident to antennas physically sized to have a resonant frequency of about 300 Mhz. FIG. 11 illustrates a graph of modeled current vs time 736 for the antennas of FIGS. 9 and 10. As shown in FIG. 11, antenna current changes direction when the switch transitions from an open to a short circuit. In the model results shown, the short-circuit antenna has a current 740 at the feed point approximately 180 degrees out of phase from the open-circuit antenna current 738. Thus, the inverted F antenna 700 shows a 180 degree phase shift in the current at the antenna feed point upon switching from an open circuit configuration to a closed circuit configuration.

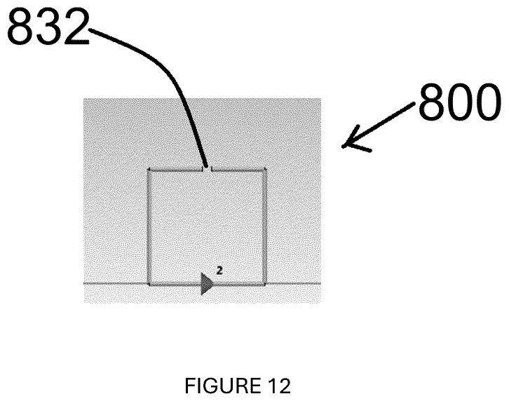

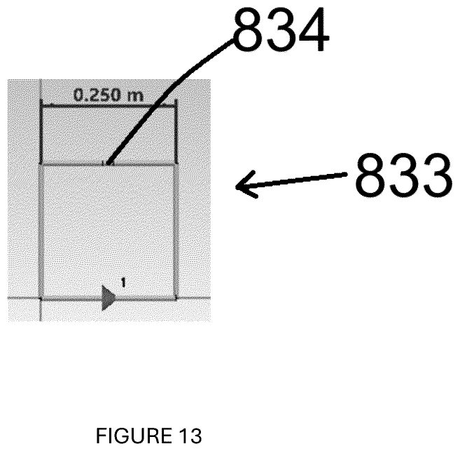

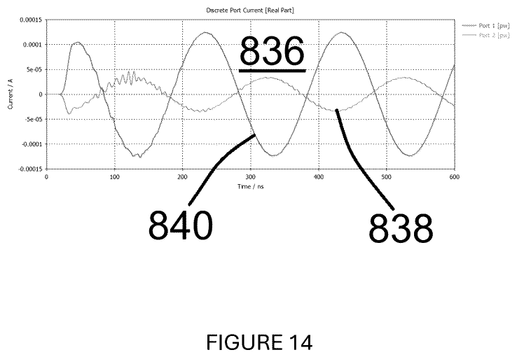

FIGS. 12-14 illustrate software modeling results for an electrically small nonlinear loop antenna 800. FIG. 12 illustrates an electrically small nonlinear loop antenna in an open switch 830 configuration, while FIG. 13 illustrates an electrically small nonlinear loop antenna 833 in a closed switch 834 configuration. The models used a 10 MHz plane wave incident to antennas physically sized to have a resonant frequency of about 300 Mhz. FIG. 14 illustrates a graph of modeled current vs time 836 for the antennas of FIGS. 12 and 13. As shown in FIG. 14, antenna current changes direction when the switch transitions from an open to a short circuit. In the model results shown, the short-circuit antenna has a current 838 at the feed point approximately 180 degrees out of phase from the open-circuit antenna current 840. Thus, loop antenna 800 shows a 180 degree phase shift in the current at the antenna feed point upon switching from an open circuit configuration to a closed circuit configuration.

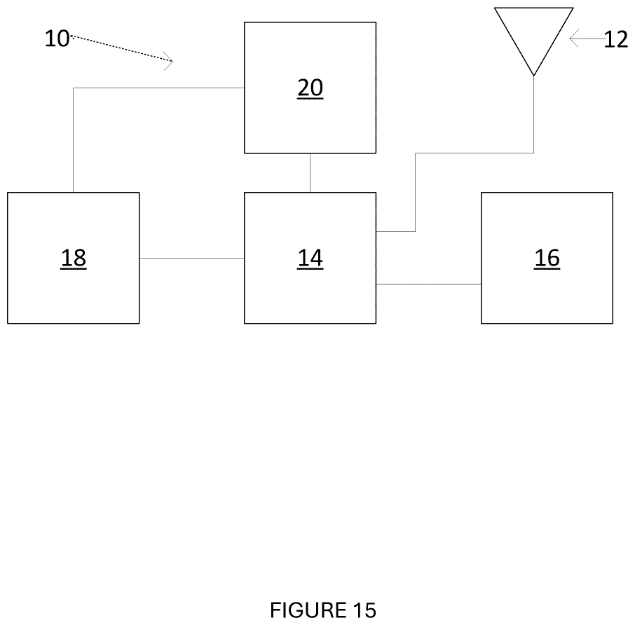

FIG. 15 illustrates an exemplary embodiment of a wireless device incorporating a nonlinear electrically small antenna. Devices can include but are not limited to a cellular phone, a smart watch, a radio-controlled clock, a Wi-Fi device, and/or an Internet of Things (IoT) device that uses at least one antenna to receive signals. In the exemplary embodiment shown, device 10 includes nonlinear electrically small antenna 12 coupled to and communicating with a CPU/control 14. FIG. 15 further illustrates CPU/control 14 coupled to and communicating with memory 16 and power element 18. Additionally, receiver element 20 is shown coupled to and communicating with power element 18 and CPU/control 14, although other arrangements are contemplated.

### CONCLUSION

Having described the basic concept of the embodiments, the foregoing detailed disclosure is intended to be presented by way of example. Terms should be interpreted as indicating that insubstantial or inconsequential modifications or alterations and various improvements of the subject matter described and claimed are considered to be within the scope of the embodiments as recited in the claims. Additionally, the recited order of the elements or sequences, or the use of numbers, letters or other designations is not intended to limit any claimed processes to any order unless expressly stated otherwise. All ranges disclosed herein also encompass any and all possible sub-ranges and combinations of sub-ranges thereof. As a non-limiting example, each range discussed herein can be readily broken down into a lower third, middle third and upper third, etc. As will also be understood by one skilled in the art all language such as up to, at least, greater than, less than, and the like refer to ranges which are subsequently broken down into sub-ranges as discussed above.

As utilized herein, the terms “about,” “substantially,” and other similar terms are intended to have a broad meaning in conjunction with the common and accepted usage by those having ordinary skill in the art to which the subject matter of this disclosure pertains. As utilized herein, the term “approximately equal to” shall carry the meaning of being within 15, 10, 5, 4, 3, 2, or 1 percent of the subject measurement, item, unit, or concentration, with preference given to the percent variance. It should be understood by those of skill in the art who review this disclosure that these terms are intended to allow a description of certain features described and claimed without restricting the scope of these features to the exact numerical ranges provided. Accordingly, the embodiments are limited only by the following claims and equivalents thereto. All publications and patent documents cited in this application are incorporated by reference in their entirety for all purposes to the same extent as if each individual publication or patent document were so individually denoted.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure. The recitation of numerical ranges by endpoints includes all numbers within that range (e.g. 1 to 5 includes 1, 1.5, 2, 2.75, 3, 3.80, 4, and 5). Where members are grouped together in a common manner, such as in a Markush group, the present subject matter encompasses not only the entire group listed as a whole, but each member of the group individually and all possible subgroups of the main group. Accordingly, for all purposes, the present subject matter encompasses not only the main group, but also the main group absent one or more of the group members. The present subject matter also envisages the explicit exclusion of one or more of any of the group members in the claimed subject matter.

It will be understood that many additional changes in the details, materials, steps and arrangement of parts, which have been herein described and illustrated to explain the nature of the subject matter, may be made by those skilled in the art within the principle and scope as expressed in the appended claims.

What is claimed is:

1. A nonlinear antenna, comprising:
a driven element configured to receive a signal of frequency fᵢ incident to the driven element; and
a switch electrically connected to the driven element and configured to increase an electrical size of the driven element by interrupting a current flow in the driven element by switching on and off at a switching frequency f_{SW} that is higher than the incident frequency fi.

2. The nonlinear antenna of claim 1, wherein the switching frequency f_{SW} is greater than twice the incident frequency fi.

3. The nonlinear antenna of claim 1, wherein the driven element is configured to receive an incident signal selected from the group consisting of an AM signal, an FM signal, a PSK signal, an FDMA signal, a TDMA signal, a CDMA signal, and an OFDM signal.

4. The nonlinear antenna of claim 1, wherein the switch switching frequency f_{SW} is adjustable.

5. The nonlinear antenna of claim 4, wherein the switch is mechanical.

6. The nonlinear antenna of claim 4, wherein the switch is a plasma switch.

7. The nonlinear antenna of claim 4, wherein the switch is a field-effect transistor.

8. The nonlinear antenna of claim 7, wherein the field effect transistor is selected from the group consisting of a JFET, a MOSFET, a MISFET, and an IGFET.

9. The nonlinear antenna of claim 4, wherein the switch is selected from the group consisting of a mechanical switch, a BJT, a Schottky diode, an optical switch, a plasma switch, a pin diode, a Gallium Arsenide switch, and an IGBT.

10. The nonlinear antenna of claim 1, further comprising an impedance matching circuit electrically connected to the driven element and an antenna feed at a point opposite the switch.

11. A wireless device, comprising:
a communication element configured to receive an electromagnetic signal;
an antenna connected to the communication element and having a driven element configured to receive a signal of frequency fᵢ incident to the driven element; and
a switch electrically connected to the driven element and configured to increase an electrical size of the driven element by interrupting a current flow in the driven element by switching on and off at a switching frequency f_{SW} that is higher than the incident frequency fi.

12. The wireless device of claim 11, wherein the switching frequency f_{SW} is greater than twice the incident frequency fi.

13. The wireless device of claim 11, wherein the antenna is a dipole antenna.

14. The wireless device of claim 11, wherein the antenna is a half-folded dipole antenna.

15. The wireless device of claim 11, wherein the antenna is a folded dipole.

16. The wireless device of claim 11, wherein the antenna is selected from the group consisting of an inverted F antenna, a T-match dipole antenna, and a loop antenna.

17. The wireless device of claim 11, wherein the communication element is a cellular phone.

18. The wireless device of claim 11, wherein the communication element is a wireless router.

19. The wireless device of claim 11, wherein the communication device is an element of an Internet of Things (IoT) network.

20. A method of inducing a nonlinear effect on an antenna boundary, comprising:
receiving an electromagnetic signal of a first frequency incident to an antenna boundary; and
changing an electrical size of the antenna by opening and closing an antenna conducting path at a second frequency that is higher than the first frequency.
